(19) United States
(12) Patent Application Publication
(10) Pub. No.: US 2010/0310362 A1
(43) Pub. Date: Dec. 9, 2010

(54) Housing for a Blade Wheel

(75) Inventor: Siegfried Botsch, Grafenau (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/738,584

(22) PCT Filed: Aug. 12, 2008
(86) PCT No.: PCT/EP2008/006618

§ 371 Date: Aug. 23, 2010

(30) Foreign Application Priority Data
Oct. 19, 2007 (DE) 10 2007 050 124.4

(51) Int. Cl. F04D 29/44; B23P 15/04

(52) U.S. Cl. 415/200; 29/889.2

(57) ABSTRACT

A turbine housing for a turbine wheel of an exhaust gas turbocharger, is formed from a casting material and comprises at least two flow chambers that are separated from each other by a flow separator. The flow separator is embodied as a separate insert especially as a sheet metal part or a cast part, that is embedded into a wall region of the housing.

This application is a national stage of PCT International Application No. PCT/EP2008/006618, filed Aug. 12, 2008, which claims priority under 35 U.S.C. §119 to German Patent Application No. 10 2007 050 124.4, filed Oct. 19, 2007, the entire disclosure of which is herein expressly incorporated by reference.

### BACKGROUND AND SUMMARY OF THE INVENTION

The invention relates to a housing for a blade wheel, especially a turbine housing for a turbine wheel of an exhaust gas turbocharger, and to a method for producing such a housing.

Such housings, especially turbine housings for turbine wheels of exhaust gas turbochargers in commercial vehicles, are often designed as so-called twin-flow housings, where two flows or chambers are separated by a flow separator. The mode of operation or the performance of a turbocharger is closely coupled to the gap clearance, which describes the distance between the tip of the flow separator and the corresponding housing walls.

It is known from the state of the art to form this flow separator in one piece with the remaining housing wall from a housing created by a casting material. The housing wall and the flow separator are thereby cast in one piece in one process step. To provide a gap clearance which is as low as possible and precise, very high demands must be met by the casting technique, especially of the casting core. The casting core is very thin exactly in the gap region and still subject to high loads during casting.

In the region of the flow separator, tensions can additionally occur during operation, which can cause a tear formation in the extreme case in the region of the flow separator and resulting therefrom a performance loss or even a breakdown of the exhaust gas turbocharger, so that in UK patent document GB 2 186 328 A is already known a housing where the flow separator is clamped between two housing halves as a separate sheet.

One object of the present invention is to provide a housing and a casting method, by which the flow separator can be arranged between the two associated flows with a small and precise gap clearance.

This and other objects and advantages are achieved by the method and apparatus according to the invention, in which the flow separator is formed as a separate insert, especially as a sheet metal part or cast part that is cast into a wall region of the housing. In this manner, it is possible to arrange the flow separator in a production-oriented manner in an especially simple and favorable manner within the housing. A further advantage is that, by means of the separate flow separator, which is especially formed of a sheet metal part or a cast part, extremely small gap clearances of the gaps can be created between the flow separator and the corresponding wall region of the housing, which would for example not be possible with a flow separator created from the cast material of the housing itself due to the casting tolerances which are too high. The respective gap clearances can thus be adjusted in an extremely exact manner, which finally leads to an efficiency increase of the exhaust gas turbocharger. Still a further advantage is that a separate insert has a low susceptibility to tearing, so that a resulting possible performance loss with the present housing or even a breakdown of the exhaust gas turbocharger can be avoided reliably.

It is obvious that housings with several flows can naturally also be created, where for example a plurality of inserts are arranged relative to each other in the manner of a fir tree.

According to the invention, the insert can have different materials, production methods and forms. A sheet metal part, especially of stainless steel or a cast steel part are for example very suitable. With the cast part, it is possible to realize surface contours or more complex forms in an especially simple manner.

In a further arrangement of the invention, it has been shown to be advantageous if a with a gap clearance of about 2 mm to about 6 mm (preferably 4 mm) is provided between the insert and a corresponding wall region of the housing. Such a narrow gap favors particularly good exhaust gas values.

In a further arrangement of the invention, it has been shown to be advantageous if the insert is engaged behind in a form and/or material-fit manner, and partially in a metallurgic manner, so that an especially reliable connection of the insert with the corresponding wall region of the housing can be achieved.

In a further arrangement of the invention, the housing is made of a thin-walled cast steel and/or the insert of a steel, especially a high temperature-resistant steel. A housing of a thin-walled cast steel can be produced in a particularly weight-favorable manner. An insert of steel, especially highly rigid steel thereby has the advantage to be especially resistant against the medium to be compacted.

It has further been shown to be advantageous if the insert is arranged at the housing for fixing an associated casting core. The insert has thus the further function, namely to position the associated casting core in an especially reliable manner relative to the casting mold or to the subsequent housing, so as to achieve extremely even and reproducible gap clearances.

The invention is especially distinguished in that the insert is cast into the associated wall region of the housing. An especially simple and cost-efficient method results thus, by which the housing described previously can be produced.

In a further arrangement of the invention, it has been shown to be advantageous if the insert is integrated in a casting core, which is arranged in a corresponding casting mold prior to casting. The insert is thus positioned in a particularly advantageous and position-safe manner within the housing or the casting mold. A very precise or narrow gap clearance results, in a particularly advantageous manner, between the insert and the corresponding wall regions of the housing.

It is especially advantageous that the sheet metal part-type flow separator represents a mechanical support for the casting core in the region of the gap. As a relatively low thickness is present in this region, the insert contained in the casting core represents a considerable mechanical reinforcement. This is very advantageous with the casting core production, for example by a core firing process, and with the casting process itself. Comparatively low gap clearances are thereby available for the first time in a sufficient quality.

So as to enable a particularly simple production of the casting core, it is fired together with the insert, preferably in one process step.

In a further arrangement of the invention, it has been shown to be additionally advantageous if the casting core is positioned and held in the casting mold by at least one core support, so as to achieve thus a particularly even and reproducible positioning of the insert within the housing.

The insert furthermore serves to hold and/or reinforce the casting core in a further arrangement of the invention, so that it is held in a particularly advantageous manner within the casting mold. A particularly advantageous reinforcement results if the insert correspondingly reinforces the casting core at its thinnest part (that is, especially in the region of the gap between the insert and the corresponding wall region).

It has finally been shown to be advantageous if the insert is cast into the wall region of the housing engaging behind in a form-fit manner form and/or a material-fit manner, so as to achieve an optimum connection of the separate insert with the cast housing.

Other objects, advantages and novel features of the present invention will become apparent from the following detailed description of the invention when considered in conjunction with the accompanying drawings.

### BRIEF DESCRIPTION OF THE DRAWINGS

FIG. 1 is an axial sectional view through a turbine housing for a turbine wheel of an exhaust gas turbocharger, which is formed with two flows, and whose two flows are separated from each other by a flow separator, which is designed as a separate insert, especially of a sheet metal part or a cast part and is cast into the corresponding wall region of the housing; and

FIG. 2 is an enlarged sectional representation showing a part of the two flows according to FIG. 1, which are separated from each other by the flow separator formed as a separate insert, wherein a casting core can be seen, by means of which the insert is held within the casting mold during the casting process.

### DETAILED DESCRIPTION OF THE DRAWINGS

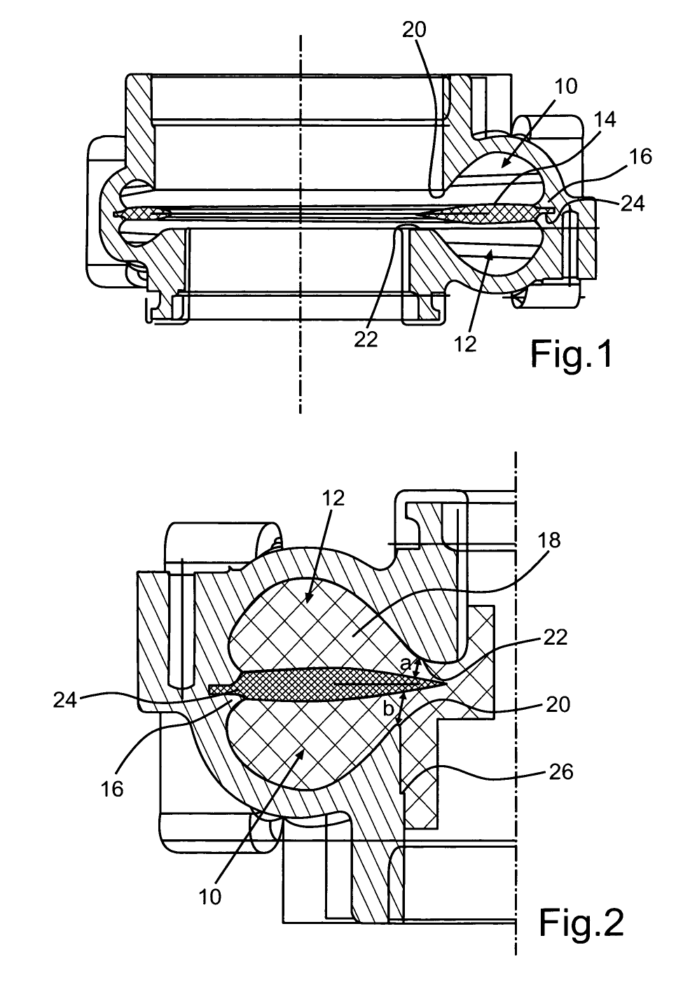

In FIG. 1 is an axial sectional view of a turbine housing for a turbine wheel of an exhaust gas turbocharger (not shown), such as is presently especially used with a commercial vehicle or also with passenger vehicles. The turbine housing comprises two chambers or flows 10, 12, which are separated from each other by a flow separator in the form of a separate insert 14. In the present embodiment, the insert 14 is produced of a metal alloy and formed as a sheet metal part. A highly temperature-resistant steel can thereby be used especially, which is suitable to resist the medium flowing in the interior of the housing. It should be noted that, within the scope of the invention, another material, for example on the basis of ceramics, could be used instead of a metal alloy or a sheet metal part or a cast part.

The housing itself is designed in the present case of a casting material, especially as thin-walled cast steel. The sheet metal part or the cast part can thus be provided of different materials—depending on use—to for example have a corresponding durability, elasticity, temperature resistance, wear resistance and for example also a lower or adjusted thermal expansion coefficient.

Together with FIG. 2, which shows an enlarged (and rotated) sectional view of part of the present housing, it can be seen that the two flows 10, 12 are cast in a corresponding wall region 16 of the housing. This takes place in the present case by a method for producing the housing, where the insert 14 is initially integrated in a casting core 18 (shown in FIG. 2), which is arranged within a corresponding casting mold prior to the casting of the housing. In the present case, the casting mold 18 is a sand core, which is fired together with the insert 14 in one process step. The insert thereby serves as a core support for the two flows 12 and 10. The insert 14 is held and fixed in an extremely reliable and exact manner within the casting mold, so that an extremely exact and reproducible casting result adjusts itself.

Additionally, it is achieved by means of the casting core 18 that a relatively small gap a, b with a gap measurement of about 2 mm to about 6 mm (and preferably about 4 mm) adjusts itself between the insert 14 and the respective associated wall region 20, 22. The casting core 18 is thereby is reinforced by the insert 14 itself in the near region to the wall regions 20, 22 of the housing—that is, at its thinnest part.

The casting core 18 is positioned and held in the casting mold by a corresponding core bearing 26, so that the desired small gap a, b results therefrom after the casting of the casting melt between the respective wall region 20, 22 of the housing and the insert 14. The insert 14 is cast in correspondingly on the side opposite the wall regions 20, 22 of the housing, wherein a corresponding end region 24 of the insert 14 serves to hold the casting core 18 within the casting mold. In other words, the insert 14 then also serves for the core fixation,—especially against rotation and displacement—within the casting mold. The insert 14 thus not only serves as a core support in the region of its free end (that is, in the region of the gaps a, b), but also for the positioning of the casting core 18. The insert 14 can thereby be cast in such a manner in the corresponding edge region 16 of the housing that a form-fit engagement behind and/or material-fit or metallurgical connection results between the insert 14—especially the sheet metal part or a cast part—and the casting melt or the cast material.

Within the scope of the invention, the housing naturally may also comprise more than the two flows 10, 12 as shown, which are for example inserts 14 arranged or formed to each other in the manner of a fir tree. However, it can be seen that the cast insert 14 can be produced as an extremely good reproducible housing, which can be produced with an extremely low and exact gap clearance respectively in the region of the gaps a, b, so that extremely favorable exhaust gas values can be achieved altogether by means of the exhaust gas turbocharger.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-11. (canceled)

12. A turbine housing for a turbine wheel of an exhaust gas turbocharger, which housing is formed from a casting material and has at least two flow chambers that are separated from each other by a flow separator; wherein:
the flow separator comprises a separate insert, which is cast into a wall region of the housing;
the insert is cast into the wall region of the housing engaging behind in a form-fit manner;
the housing comprises a thin-walled cast steel; and
the insert is made of a high temperature-resistant steel.

13. The housing according to claim 12, wherein a gap with a clearance of about 2 mm to 6 mm is provided between the insert and the respectively corresponding wall region.

14. The housing according to claim 13, wherein the gap is 4 mm.

15. The housing according to claim 12, wherein the insert is cast in a material-fit manner.

16. The housing according to claim 12, wherein the insert is one of a metal sheet part and a cast part that is cast into the housing.

17. A method for producing a turbine housing for a turbine wheel of an exhaust gas turbocharger, wherein the housing, which has at least two flow chambers that are separated from each other by a flow separator, is formed from a casting material, said method comprising:
fixing an insert, provided as a flow separator, in a casting core; and
casting the casting core by the housing material in such a manner that a part of the insert is cast into a wall region of the housing;
wherein the insert is cast into the wall region of the housing, engaging behind in a form-fit manner.

18. The method according to claim 17, wherein said insert comprises one of a sheet metal part and a cast part, which is integrated completely into a casting core for an inner contour of the housing, apart from a region provided for casting into the housing.

19. The method according to claim 18, wherein the casting core with the insert fixed therein is fired in a single process step.

20. The method according to claim 17, wherein the casting core is positioned and held in the casting mold by at least one core support.

21. The method according to claim 17, wherein the casting core is held or reinforced in the casting mold by the insert.

22. The method according to claim 18, wherein the insert is cast into the wall region of the housing, engaging behind in at least one of a form-fit manner and material-fit manner.
